(19) United States
(12) Patent Application Publication
(10) Pub. No.: US 2020/0279148 A1
(43) Pub. Date: Sep. 3, 2020

(54) MATERIAL STRUCTURE ANALYSIS METHOD AND MATERIAL STRUCTURE ANALYZER

(71) Applicant: Preferred Networks, Inc., Tokyo (JP)

(72) Inventors: Daisuke MOTOKI, Tokyo (JP); Kosuke NAKAGO, Tokyo (JP)

(21) Appl. No.: 16/784,717

(22) Filed: Feb. 7, 2020

(30) Foreign Application Priority Data
Mar. 1, 2019 (JP) 2019-037758

(51) Int. Cl. G06N 3/04; G06N 3/08

(52) U.S. Cl. CPC G06N 3/0454; G06N 3/084

(57) ABSTRACT

A material structure analysis scheme for using machine learning to predict a general structure of an arbitrary material is provided. One aspect of the present disclosure relates to a material structure analysis method, including acquiring, by one or more processors, structural data representing a structure of a material and spectral data representing a spectrum of a material, inputting, by the one or more processors, the structural data to a first neural network to acquire a structural feature from the first neural network, inputting, by the one or more processors, the spectral data to a second neural network to acquire a spectral feature from the second neural network, and determining, by the one or more processors, a degree of coincidence between the material corresponding to the structural data and the material corresponding to the spectral data based on the structural feature and the spectral feature.

### CROSS-REFERENCE TO RELATED APPLICATIONS

The present application is based on and claims priority to Japanese patent application No. 2019-037758 filed on Mar. 1, 2019 with the Japanese Patent Office, the entire contents of which are hereby incorporated by reference.

### BACKGROUND

### 1. Technical Field

The disclosure herein relates to a material structure analysis.

### 2. Description of the Related Art

As one field of chemistry for analyzing and determining chemical structures of substances, materials and so on, the material structure analysis is known. In the material structure analysis, for example, in a CASE (Computer Assisted Structure Elucidation) system, spectral data obtained from a material is analyzed or elucidated by a computer to predict the chemical structure of the material.

Recent advances in machine learning techniques, such as deep learning, have led to proposals for approaches to the material structure analysis using machine learning. For example, an approach to the material structure analysis has been proposed for using the machine learning to determine whether a to-be-analyzed material has a predetermined type of partial structure based on measured spectral data. Also, an approach to the material structure analysis has been proposed for using the machine learning to determine into which of predefined classes the spectral data of a to-be-analyzed material may be classified. In addition, it is well-known to those skilled in the art that spectral measurements, which serve as the basis of the material structure analysis, may vary depending on the environmental state, the material state, the measurement scheme or the like at the measurement.

### SUMMARY

One objective of the present disclosure is to provide a material structure analysis scheme for predicting the whole structure of an arbitrary material with use of the machine learning.

In order to overcome the objective, one aspect of the present disclosure relates to a material structure analysis method, comprising: acquiring, by one or more processors, structural data representing a structure of a material and spectral data representing a spectrum of a material; inputting, by the one or more processors, the structural data to a first neural network to acquire a structural feature from the first neural network; inputting, by the one or more processors, the spectral data to a second neural network to acquire a spectral feature from the second neural network; and determining, by the one or more processors, a degree of coincidence between the material corresponding to the structural data and the material corresponding to the spectral data based on the structural feature and the spectral feature.

A further aspect of the present disclosure relates to a material structure analysis method, comprising: acquiring, by one or more processors, structural data representing a structure of a to-be-predicted material; inputting, by the one or more processors, the structural data to a first neural network to acquire a structural feature from the first neural network; and inputting, by the one or more processors, the structural feature to a second neural network to acquire spectral data of the to-be-predicted material from the second neural network.

A still further aspect of the present disclosure relates to a material structure analysis method, comprising: acquiring, by one or more processors, spectral data representing a spectrum of a to-be-predicted material; inputting, by the one or more processors, the spectral data to a first neural network to acquire a spectral feature from the first neural network; and inputting, by the one or more processors, the spectral feature to a second neural network to acquire structural data of the to-be-predicted material from the second neural network.

### BRIEF DESCRIPTION OF THE DRAWINGS

Other objects and further features of the present disclosure will be apparent from the following detailed description when read in conjunction with the accompanying drawings, in which:

FIG. 1 is a schematic diagram for illustrating a material structure analyzer according to one embodiment of the present disclosure;

FIG. 2 is a block diagram for illustrating a functional arrangement of the material structure analyzer according to one embodiment of the present disclosure;

FIG. 3 is a flowchart for illustrating a training process of neural networks in the material structure analyzer according to one embodiment of the present disclosure;

FIG. 4 is a schematic diagram for illustrating a material structure analyzer according to one embodiment of the present disclosure;

FIG. 5 is a block diagram for illustrating a functional arrangement of the material structure analyzer according to one embodiment of the present disclosure;

FIG. 6 is a flowchart for illustrating a training process of neural networks in the material structure analyzer according to one embodiment of the present disclosure;

FIG. 7 is a schematic diagram for illustrating a material structure analyzer according to one embodiment of the present disclosure;

FIG. 8 is a block diagram for illustrating a functional arrangement of the material structure analyzer according to one embodiment of the present disclosure;

FIG. 9 is a flowchart for illustrating a training process of neural networks in the material structure analyzer according to one embodiment of the present disclosure;

FIG. 10 is a schematic diagram for illustrating a material structure analyzer according to one embodiment of the present disclosure;

FIG. 11 is a schematic diagram for illustrating a material structure analyzer according to one embodiment of the present disclosure;

FIG. 12 is a block diagram for illustrating a functional arrangement of the material structure analyzer according to one embodiment of the present disclosure;

FIG. 13 is a flowchart for illustrating a training process of neural networks in the material structure analyzer according to one embodiment of the present disclosure;

FIG. 14 is a schematic diagram for illustrating a material structure analyzer according to one embodiment of the present disclosure;

FIG. 15 is a block diagram for illustrating a functional arrangement of the material structure analyzer according to one embodiment of the present disclosure;

FIG. 16 is a flowchart for illustrating a training process of neural networks in the material structure analyzer according to one embodiment of the present disclosure; and

FIG. 17 is a block diagram for illustrating a hardware arrangement of the material structure analyzer according to one embodiment of the present disclosure.

### DETAILED DESCRIPTION

In the following embodiments, a material structure analyzer using machine learning is disclosed.

Briefly, a material structure analyzer according to one embodiment of the present disclosure uses a structural data neural network (for example, which may be implemented with a graph convolutional neural network) for extracting a structural feature from structural data representing the structure of a material and a spectral data neural network (for example, which may be implemented with a convolutional neural network) for extracting a spectral feature from spectral data representing the spectrum of a material to acquire the structural feature and the spectral feature from incoming structural data and spectral data and determine the degree of coincidence between the material corresponding to the structural data and the material corresponding to the spectral data based on the acquired structural feature and spectral feature.

According to the present embodiment, for example, when spectral data of a to-be-analyzed material is provided, the material structure analyzer performs the above-stated processes on the structural data of a candidate material of the to-be-analyzed material (for example, data described in accordance with SMILES (Simplified Molecular Input Line Entry System) notation, InChI (International Chemical Identifier) notation or the like) and the provided spectral data to determine the degree of coincidence between the to-be-analyzed material and the candidate material. Users can predict which of the candidate materials corresponds to the to-be-analyzed material based on the degree of coincidence of the respective candidate materials determined by the material structure analyzer.

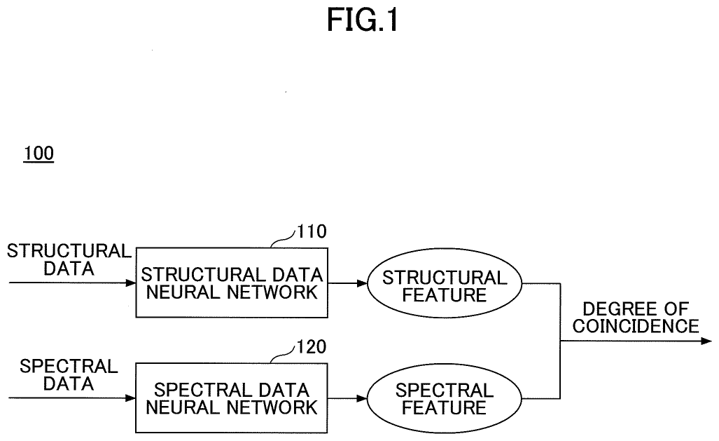

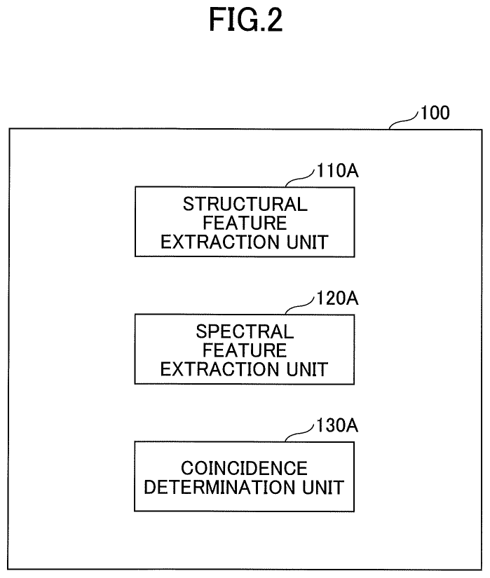

First, a material structure analyzer according to one embodiment of the present disclosure is described with reference to FIGS. 1 and 2. FIG. 1 is a schematic diagram for illustrating a material structure analyzer according to one embodiment of the present disclosure.

As shown in FIG. 1, a material structure analyzer 100 includes a structural data neural network 110 and a spectral data neural network 120. However, the material structure analyzer 100 according to the present disclosure may not necessarily include all or a part of the structural data neural network 110 and the spectral data neural network 120 and may access and use all or the part of the structural data neural network 110 and the spectral data neural network 120 stored in one or more external devices (not shown).

The structural data neural network 110 extracts a structural feature from structural data representing the structure of a material. The structural data may, for example, be a graphic representation of the structure of the material described in SMILES notation, InChI notation or the like. The structural data neural network 110 is trained by a training process described in detail below and converts incoming structural data into a structural feature representative of the structure of the material. For example, the structural data neural network 110 may be a graph convolutional neural network that allows structural data of any data size to be processed and may output an n-dimensional vector as the structural feature.

The spectral data neural network 120 extracts a spectral feature from spectral data representing the spectrum of a material. The spectral data are typically one-dimensional waveform data and may represent any spectrum for use in structural analysis of materials, such as mass spectra by mass spectrometry, infrared (IR) spectra, X-ray spectra, Raman spectroscopy, NMR (Nuclear Magnetic Resonance) spectra by nuclear magnetic resonance spectroscopy, and spectra by LIBS (Laser-Induced Breakdown Spectroscopy). The spectral data neural network 120 is trained by a training process described in detail below and converts incoming spectral data into a spectral feature representing the spectrum of a material. For example, the spectral data neural network 120 may be a convolutional neural network and may output an n-dimensional vector as the spectral feature.

FIG. 2 is a block diagram for illustrating a functional arrangement of the material structure analyzer according to one embodiment of the present disclosure. As shown in FIG. 2, the material structure analyzer 100 includes a structural feature extraction unit 110A, a spectral feature extraction unit 120A and a coincidence determination unit 130A.

The structural feature extraction unit 110A extracts a structural feature from structural data representing the structure of a material with use of the structural data neural network 110. Namely, the structural feature extraction unit 110A inputs the acquired structural data into the structural data neural network 110 and acquires the structural feature from the structural data neural network 110. The acquired structural feature is passed to the coincidence determination unit 130A.

The spectral feature extraction unit 120A extracts a spectral feature from spectral data representing the spectrum of a material with use of the spectral data neural network 120. Namely, the spectral feature extraction unit 120A inputs the acquired spectral data into the spectral data neural network 120 and acquires the spectral feature from the spectral data neural network 120. The acquired spectral feature is passed to the coincidence determination unit 130A.

The coincidence determination unit 130A determines the degree of coincidence between a material corresponding to the structural data and a material corresponding to the spectral data based on the structural feature and the spectral feature. Namely, upon acquiring the structural feature and the spectral feature from the structural feature extraction unit 110A and the spectral feature extraction unit 120A, respectively, the coincidence determination unit 130A determines the degree of coincidence between the material corresponding to the incoming structural data and the material corresponding to the incoming spectral data based on a metric (for example, a degree of difference, a degree of similarity or the like) between the acquired structural feature and the acquired spectral feature.

For example, the metric may be any indicator representing the degree of similarity or the degree of difference between vectors such as cosine similarity or contrast loss, and the degree of coincidence may be, for example, a normalized one of the calculated metric within a predetermined range such as the range from 0 to 1.

For example, when the spectral data of a to-be-analyzed material and the structural data of one or more candidate materials of that material are provided, the material structure analyzer 100 may perform the above-stated processes on the structural data of the respective candidate materials and the spectral data of the to-be-analyzed material to calculate the degree of coincidence between the structural data of the respective candidate materials and the to-be-analyzed material and determine the candidate material having the highest degree of coincidence as the to-be-analyzed material.

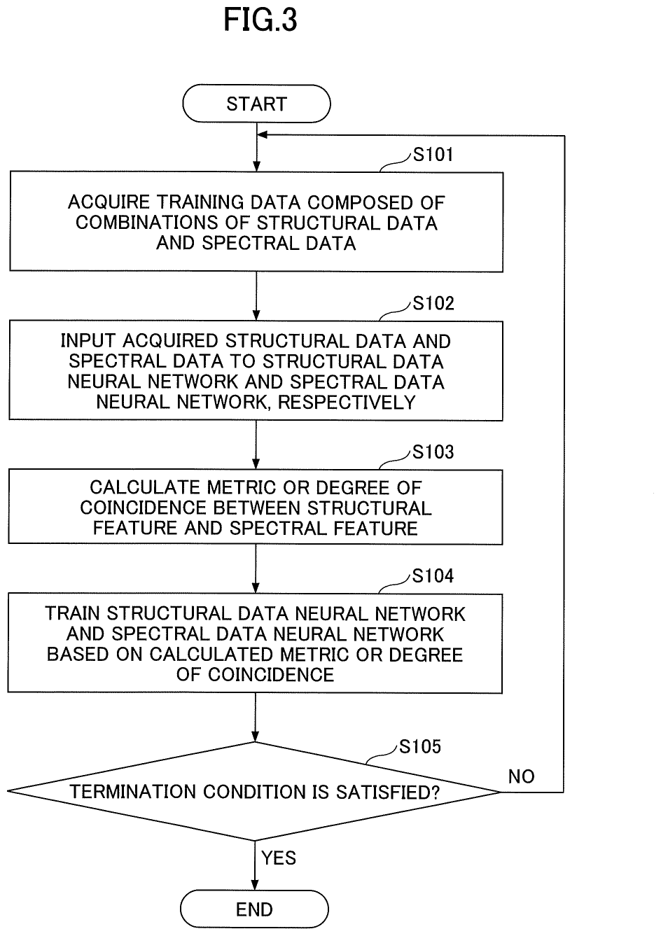

The structural data neural network 110 and the spectral data neural network 120 according to the present embodiment may be trained in accordance with a training process as shown in FIG. 3. The training process may be performed by the material structure analyzer 100 or one or more external devices (not shown), and the trained structural data neural network 110 and the trained spectral data neural network 120 may be provided to the material structure analyzer 100. Hereinafter, an embodiment of the training process performed by the material structure analyzer 100 is described.

At step S101, the material structure analyzer 100 acquires a combination of structural data and spectral data for training. For example, the combination of structural data and spectral data for training may be a combination (positive data) of structural data and spectral data of the same material or a combination (negative data) of structural data and spectral data of different materials.

At step S102, the material structure analyzer 100 inputs the acquired structural data and spectral data for training into a to-be-trained structural data neural network 110 and a to-be-trained spectral data neural network 120. For example, the structural data neural network 110 may be a graph convolutional neural network that allows structural data of any data size to be processed, and the spectral data neural network 120 may be a convolutional neural network that allows one-dimensional waveform data to be processed.

At step S103, the material structure analyzer 100 acquires a structural feature and a spectral feature from the structural data neural network 110 and the spectral data neural network 120, respectively, and calculates the metric and/or the degree of coincidence between the acquired structural feature and the acquired spectral feature.

At step S104, the material structure analyzer 100 trains the structural data neural network 110 and the spectral data neural network 120 based on the calculated metric or the degree of coincidence calculated from the metric.

In one embodiment, the structural data neural network 110 and the spectral data neural network 120 may be trained to have a higher degree of coincidence for the positive pair and a lower degree of coincidence for the negative pair.

Namely, if the incoming training data is composed of a combination (positive data) of structural data and spectral data of the same material, the material structure analyzer 100 may update parameters for the structural data neural network 110 and the spectral data neural network 120 in accordance with backpropagation method to decrease the metric (the degree of difference or the distance), that is, to increase the degree of coincidence (the degree of similarity). On the other hand, if the incoming training data is composed of a combination (negative data) of structural data and spectral data of different materials, the material structure analyzer 100 may update the parameters for the structural data neural network 110 and the spectral data neural network 120 in accordance with the backpropagation method to increase the metric (the degree of difference or the distance), that is, to decrease the degree of coincidence (the degree of similarity).

Also, in other embodiments, the structural data neural network 110 and the spectral data neural network 120 may be trained to have a larger difference between the degree of coincidence for the positive pair and the degree of coincidence for the negative pair.

Specifically, the material structure analyzer 100 may use the positive data for the spectral data of a material A, that is, a combination of the structural data of the material A and the spectral data of the material A, and the negative data for the spectral data of the material A, that is, a combination of the structural data of a material B and the spectral data of the material A, to train the structural data neural network 110 and the spectral data neural network 120 based on the structural feature of the material A, the structural feature of the material B and the spectral feature of the material A. In this case, the material structure analyzer 100 may update the parameters for the structural data neural network 110 and the spectral data neural network 120 in accordance with the backpropagation method to increase the difference between the two metrics, one of the metrics between the structural feature of the material A and the spectral feature of the material A or the degree of coincidence calculated from the metric, and the other between the structural feature of the material B and the spectral feature of the material A or the degree of coincidence calculated from the metric.

Alternatively, the material structure analyzer 100 may use the positive data for the structural data of the material A, that is, a combination of the structural data of the material A and the spectral data of the material A, and the negative data for the structural data of the material A, that is, a combination of the structural data of the material A and the spectral data of the material B, to train the structural data neural network 110 and the spectral data neural network 120 based on the structural feature of the material A, the spectral feature of the material A and the spectral feature of the material B. In this case, the material structure analyzer 100 may update the parameters for the structural data neural network 110 and the spectral data neural network 120 in accordance with the backpropagation method to increase the difference between the two metrics, one of the metrics between the structural feature of the material A and the spectral feature of the material A or the degree of coincidence calculated from the metric, and the other between the structural feature of the material A and the spectral feature of the material B or the degree of coincidence calculated from the metric.

Alternatively, the material structure analyzer 100 may consider outputs of the structural data neural network 110 and the spectral data neural network 120 as probability distributions and utilize KL (Kullback-Leibler) divergence with a prior distribution (which may be Gaussian or the like) as a loss function to update the parameters of the structural data neural network 110 and the spectral data neural network 120.

At step S105, the material structure analyzer 100 determines whether a termination condition is satisfied. The termination condition may be, for example, completion of the process on a predetermined number of training data, convergence of updating amounts of the parameters or the like.

If the termination condition is satisfied (S105: YES), the material structure analyzer 100 terminates the training process and stores the finally acquired structural data neural network 110 and the finally acquired spectral data neural network 120 as the trained structural data neural network 110 and the trained spectral data neural network 120.

On the other hand, if the termination condition is not satisfied (S105: NO), the material structure analyzer 100 returns to step S101 and processes the next training data.

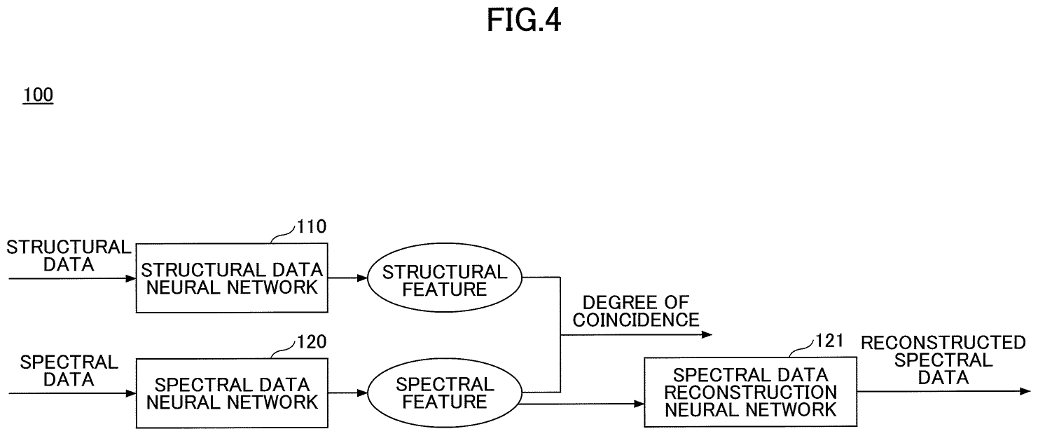

Next, the material structure analyzer according to another embodiment of the present disclosure is described with reference to FIGS. 4 to 6. In the present embodiment, the spectral data neural network 120 together with a spectral data reconstruction neural network 121 composes an auto-encoder to generate a spectral feature having an amount of information that allows incoming spectral data to be reconstructed. FIG. 4 is a schematic diagram for illustrating the material structure analyzer according to one embodiment of the present disclosure.

As shown in FIG. 4, in addition to the structural data neural network 110 and the spectral data neural network as stated above, the material structure analyzer 100 further includes the spectral data reconstruction neural network 121. However, the material structure analyzer 100 according to the present disclosure may not necessarily include all or a part of the structural data neural network 110, the spectral data neural network 120 and the spectral data reconstruction neural network 121 and may access and use all or the part of the structural data neural network 110, the spectral data neural network 120 and the spectral data reconstruction neural network 121 stored in one or more external devices (not shown). The structural data neural network 110 and the spectral data neural network 120 and calculation of the metric and the degree of coincidence according to the present embodiment are the same as the above-described embodiments, and description thereof is omitted to avoid duplication of the description.

The spectral data reconstruction neural network 121 reconstructs the spectral data of a material from the spectral feature of that material. Namely, the spectral data neural network 120 and the spectral data reconstruction neural network 121 compose an auto-encoder. As described in more detail below, the spectral data neural network 120 trained as the auto-encoder generates a spectral feature having an amount of information that allow the spectral data reconstruction neural network 121 to reconstruct the spectral data. After the training process is completed, the material structure analyzer 100 may use the spectral data reconstruction neural network 121 to reconstruct the spectral data or may use the spectral data reconstruction neural network 121 only for the purpose of the training process.

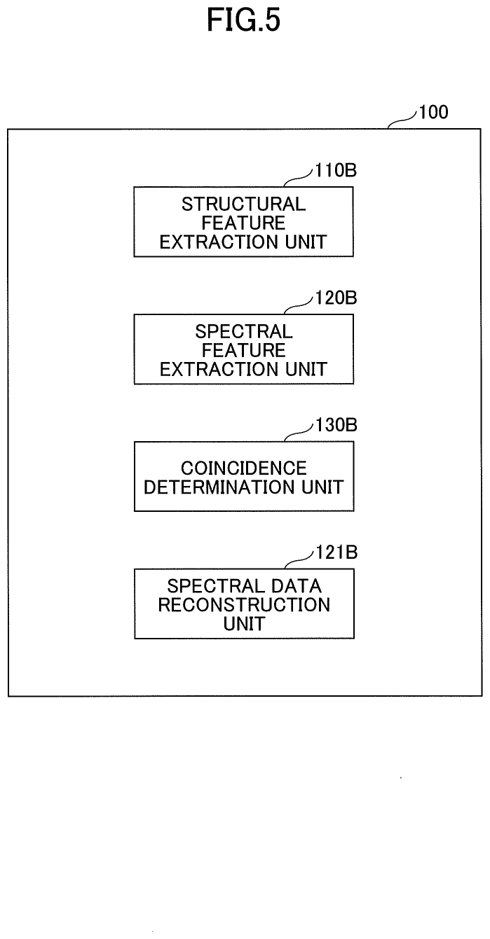

FIG. 5 is a block diagram for illustrating a functional arrangement of the material structure analyzer according to one embodiment of the present disclosure. As shown in FIG. 5, the material structure analyzer 100 includes a structural feature extraction unit 110B, a spectral feature extraction unit 120B, a coincidence determination unit 130B and a spectral data reconstruction unit 121B. The structural feature extraction unit 110B, the spectral feature extraction unit 120B and the coincidence determination unit 130B are the same as the structural feature extraction unit 110A, the spectral feature extraction unit 120A and the coincidence determination unit 130A as described above with reference to FIG. 2, and the description thereof is omitted to avoid duplication of the description.

The spectral data reconstruction unit 121B reconstructs the spectral data of a material from the spectral feature extracted from the acquired spectral data of that material. Namely, the spectral data reconstruction unit 121B together with the spectral feature extraction unit 120B composes an auto-encoder and inputs the spectral feature acquired from the spectral feature extraction unit 120B into the spectral data reconstruction neural network 121 to acquire the spectral data from the spectral data reconstruction neural network 121. By providing the spectral data reconstruction unit 121B and the spectral data reconstruction neural network 121, the spectral feature extracted from the spectral feature extraction unit 120B can have an amount of information that allows the original spectral data to be reconstructed from that spectral feature.

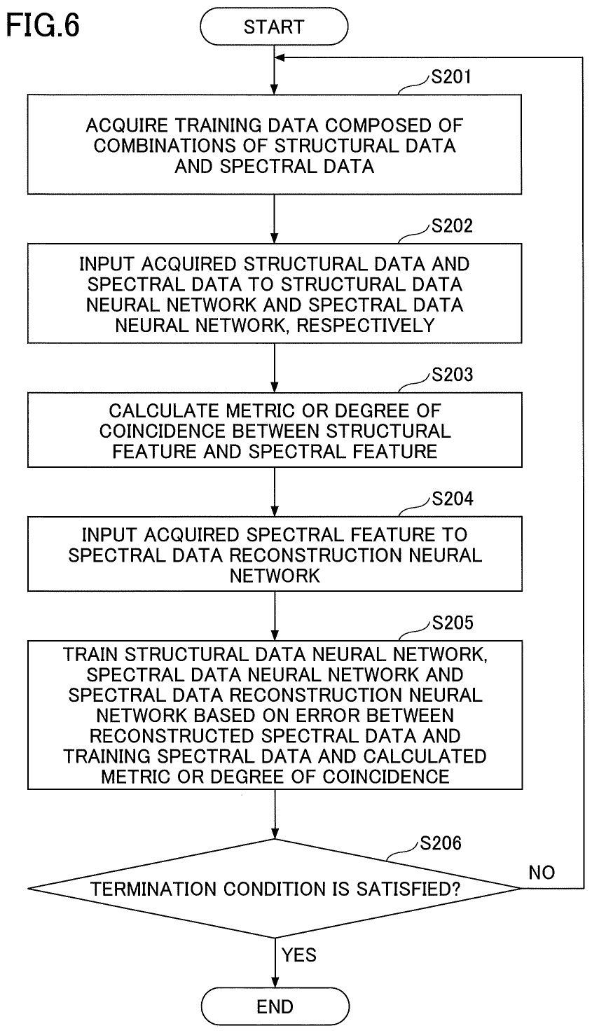

The structural data neural network 110, the spectral data neural network 120 and the spectral data reconstruction neural network 121 according to the present embodiment may be trained in accordance with a training process as shown in FIG. 6. The training process may be performed by the material structure analyzer 100 or one or more external devices (not shown), and the trained structural data neural network 110, the trained spectral data neural network 120 and the trained spectral data reconstruction neural network 121 may be provided to the material structure analyzer 100. Hereinafter, an embodiment of the training process performed by the material structure analyzer 100 is described. Steps S201 to S203 and S206 are the same as steps S101 to S103 and S105, respectively, and description thereof is omitted to avoid duplication of the description.

At step S204, the material structure analyzer 100 inputs the acquired spectral feature into the spectral data reconstruction neural network 121. Here, the spectral data neural network 120 may be a convolutional neural network and compose an auto-encoder together with the spectral data reconstruction neural network 121.

At step S205, the material structure analyzer 100 acquires the reconstructed spectral data from the spectral data reconstruction neural network 121 and calculates an error between the reconstructed spectral data and the training spectral data. The material structure analyzer 100 trains the structural data neural network 110, the spectral data neural network 120 and the spectral data reconstruction neural network 121 based on the metric calculated from the structural feature and the spectral feature or the degree of coincidence calculated from the metric and the error calculated from the reconstructed spectral data and the training spectral data. Specifically, the material structure analyzer 100 updates parameters of the structural data neural network 110, the spectral data neural network 120 and the spectral data reconstruction neural network 121 in accordance with the backpropagation method to decrease the calculated error and metric or to decrease the calculated error and increase the degree of coincidence.

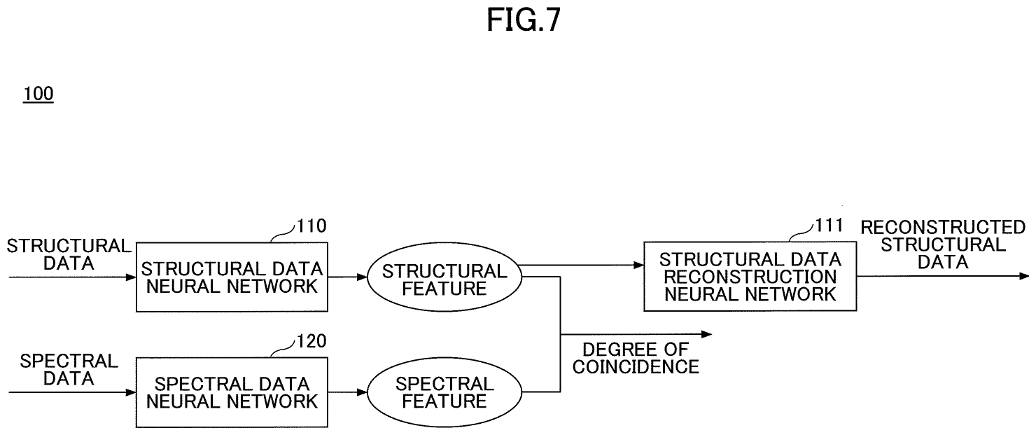

Next, the material structure analyzer according to another embodiment of the present disclosure is described with reference to FIGS. 7 to 9. In this embodiment, the structural data neural network 110 together with a structural data reconstruction neural network 111 composes an auto-encoder and generates a structural feature having an amount of information that allows incoming structural data to be reconstructed. FIG. 7 is a schematic diagram for illustrating the material structure analyzer according to one embodiment of the present disclosure.

As shown in FIG. 7, in addition to the structural data neural network 110 and the spectral data neural network 120 as stated above, the material structure analyzer 100 further includes the structural data reconstruction neural network 111. However, the material structure analyzer 100 according to the present disclosure may not necessarily include all or a part of the structural data neural network 110, the spectral data neural network 120 and the structural data reconstruction neural network 111 and may access and use all or the part of the structural data neural network 110, the spectral data neural network 120 and the structural data reconstruction neural network 111 stored in one or more external devices (not shown). The structural data neural network 110 and the spectral data neural network 120 and calculation of the metric and the degree of coincidence according to the present embodiment are the same as the above-stated embodiments, and description thereof is omitted to avoid duplication of the description.

The structural data reconstruction neural network 111 reconstructs structural data of a material from a structural feature of that material. Namely, the structural data neural network 110 and the structural data reconstruction neural network 111 compose an auto-encoder. As is described in more detail below, the structural data neural network 110 trained as the auto-encoder generates a structural feature having an amount of information that allows the structural data reconstruction neural network 111 to reconstruct the structural data. Algorithms for graph reconstruction include GraphVAE, Junction Tree VAE or the like. After the training process is completed, the material structure analyzer 100 may reconstruct the structural data with use of the structural data reconstruction neural network 111 or may use the structural data reconstruction neural network 111 only for the purpose of the training process.

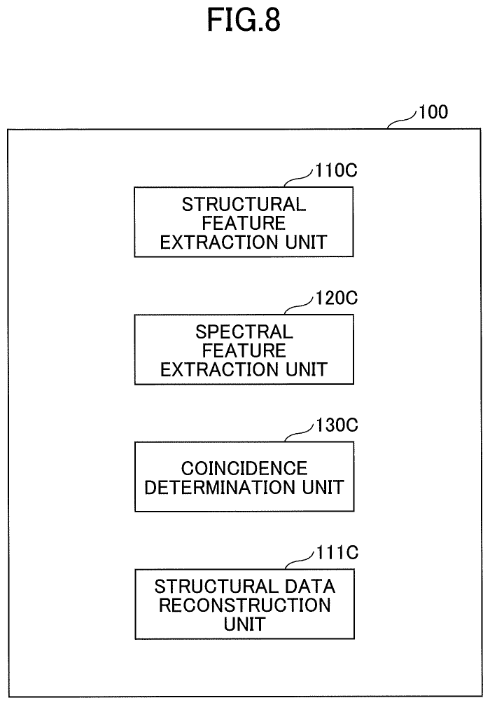

FIG. 8 is a block diagram for illustrating a functional arrangement of the material structure analyzer according to one embodiment of the present disclosure. As shown in FIG. 8, the material structure analyzer 100 includes a structural feature extraction unit 110C, a spectral feature extraction unit 120C, a coincidence determination unit 130C, and a structural data reconstruction unit 111C. The structural feature extraction unit 110C, the spectral feature extraction unit 120C and the coincidence determination unit 130C are the same as the structural feature extraction unit 110A, the spectral feature extraction unit 120A and the coincidence determination unit 130A as described above with reference to FIG. 2, and description thereof is not described to avoid duplication of the description.

The structural data reconstruction unit 111C reconstructs structural data of a material from a structural feature extracted for the acquired structural data of that material. Namely, the structural data reconstruction unit 111C together with the structural feature extraction unit 110C composes an auto-encoder and inputs the structural feature acquired from the structural feature extraction unit 110C into the structural data reconstruction neural network 111 to acquire the structural data from the structural data reconstruction neural network 111. By providing the structural data reconstruction unit 111C and the structural data reconstruction neural network 111, the structural feature extracted by the structural feature extraction unit 110C can have an amount of information that allow the original structural data to be reconstructed from the structural feature.

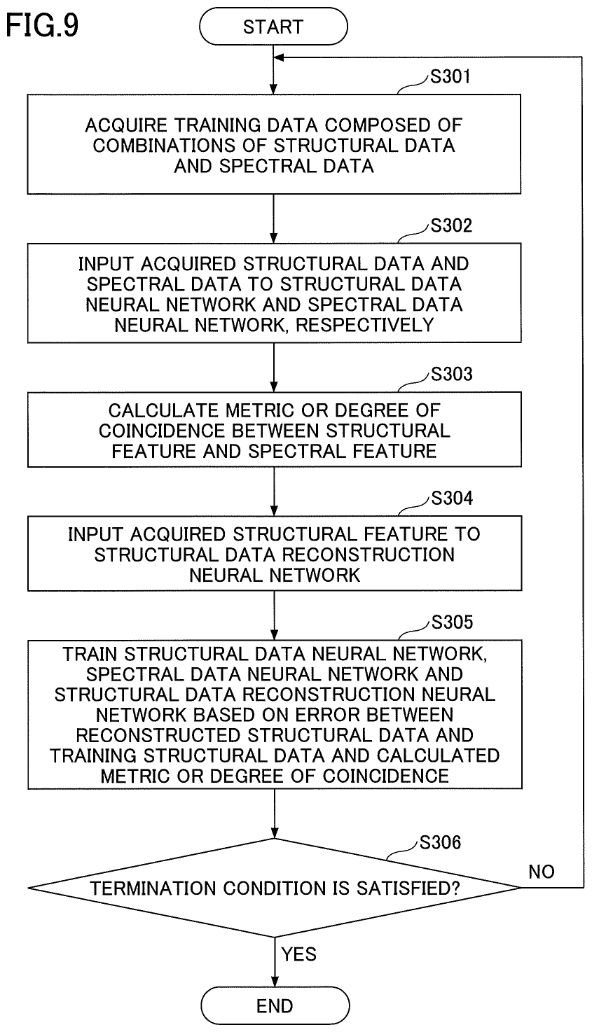

The structural data neural network 110, the spectral data neural network 120 and the structural data reconstruction neural network 111 according to the present embodiment may be trained in accordance with a training process as shown in FIG. 9. The training process may be performed by the material structure analyzer 100 or one or more external devices (not shown), and the trained structural data neural network 110, the trained spectral data neural network 120 and the trained structural data reconstruction neural network 111 may be provided to the material structure analyzer 100. Hereinafter, an embodiment of the training process performed by the material structure analyzer 100 is described. Steps S301 to S303 and S306 are the same as steps S101 to S103 and S105, respectively, and description thereof is omitted to avoid duplication of the description.

At step S304, the material structure analyzer 100 inputs the acquired structural feature into the structural data reconstruction neural network 111. Here, the structural data neural network 110 may be a graph convolutional neural network and composes an auto-encoder together with the structural data reconstruction neural network 111.

At step S305, the material structure analyzer 100 acquires the reconstructed structural data from the structural data reconstruction neural network 111 and calculates an error between the reconstructed structural data and the training structural data. Then, the material structure analyzer 100 trains the structural data neural network 110, the spectral data neural network 120 and the structural data reconstruction neural network 111 based on the metric calculated from the structural feature and the spectral feature or the degree of coincidence calculated from the metric and the error calculated from the reconstructed structural data and the training structural data. Specifically, the material structure analyzer 100 updates parameters for the structural data neural network 110, the spectral data neural network 120 and the structural data reconstruction neural network 111 in accordance with the backpropagation method to decrease the calculated error and metric or to decrease the calculated error and increase the degree of coincidence.

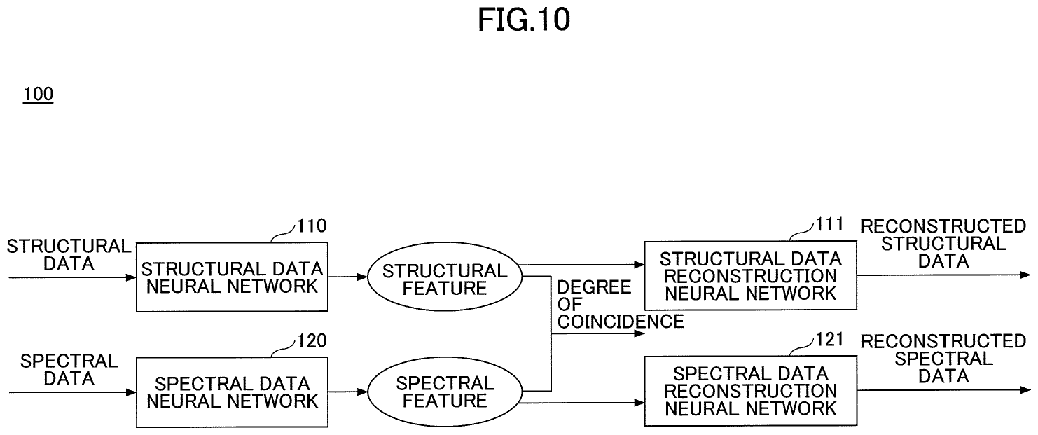

The above-stated embodiments may be combined. Namely, as shown in FIG. 10, not only the structural data neural network 110 and the structural data reconstruction neural network 111 may compose an auto-encoder, but also the spectral data neural network 120 and the spectral data reconstruction neural network 121 may compose an auto-encoder. In accordance with the present embodiment, both the structural feature and the spectral feature can have amounts of information sufficient to reconstruct the structural data and the spectral data.

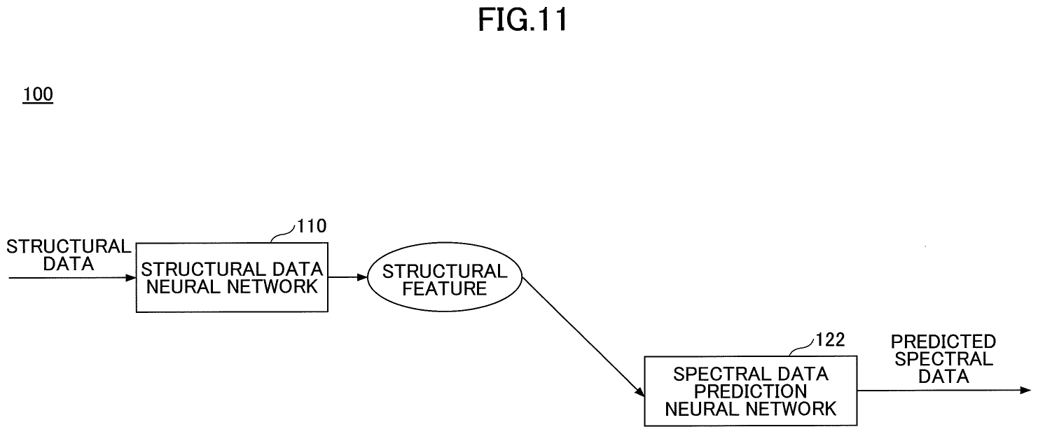

Next, the material structure analyzer according to one embodiment of the present disclosure is described with reference to FIGS. 11 to 13. In this embodiment, upon acquiring structural data, the material structure analyzer 100 predicts spectral data corresponding to a material having the acquired structural data. FIG. 11 is a schematic diagram for illustrating the material structure analyzer according to one embodiment of the present disclosure.

As shown in FIG. 11, the material structure analyzer 100 includes the structural data neural network 110 and a spectral data prediction neural network 122. However, the material structure analyzer 100 according to the present disclosure may not necessarily include all or a part of the structural data neural network 110 and the spectral data prediction neural network 122 and may access and use all or the part of the structural data neural network 110 and the spectral data prediction neural network 122 stored in one or more external devices (not shown).

The structural data neural network 110 extracts a structural feature from structural data representing the structure of a material. As stated above, the structural data neural network 110 may be a graph convolutional neural network that allows any size of structural data to be processed.

The spectral data prediction neural network 122 predicts spectral data of a material from the structural feature.

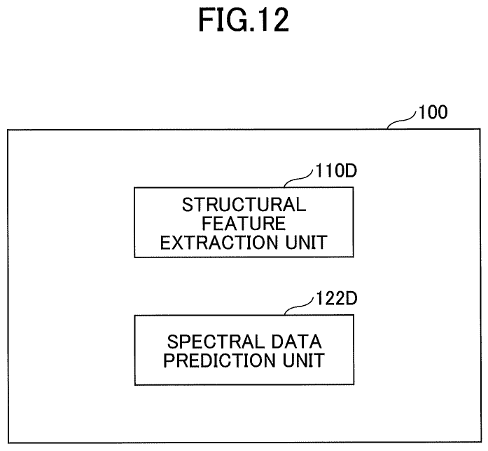

FIG. 12 is a block diagram for illustrating a functional arrangement of the material structure analyzer according to one embodiment of the present disclosure. As shown in FIG. 12, the material structure analyzer 100 includes a structural feature extraction unit 110D and a spectral data prediction unit 122D. The structural feature extraction unit 110D is the same as the structural feature extraction unit 110A as stated above with reference to FIG. 2, and description thereof is omitted to avoid duplication of the description.

The spectral data prediction unit 122D predicts spectral data of a to-be-predicted material from a structural feature with use of the spectral data prediction neural network 122. Namely, the spectral data prediction unit 122D inputs the structural feature acquired from the structural feature extraction unit 110D to the spectral data prediction neural network 122 to acquires spectral data from the spectral data prediction neural network 122. The acquired spectral data would be the spectral data of the material corresponding to the incoming structural data to the structural data neural network 110.

In one embodiment, the material structure analyzer 100 may generate a plurality of candidate structural features by varying the acquired structural feature finely and then generate a plurality of spectral data from the generated structural features.

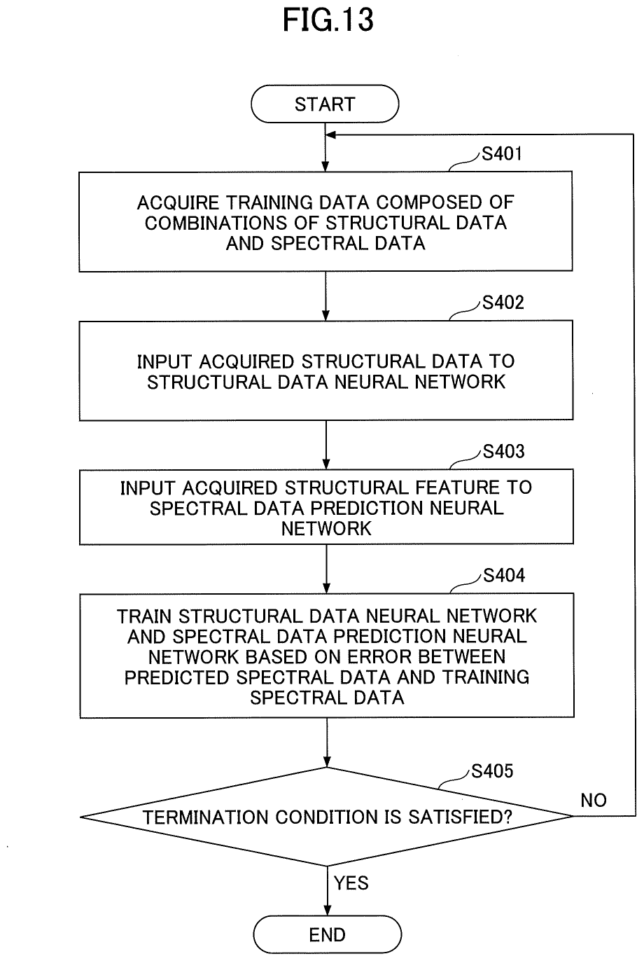

The structural data neural network 110 and the spectral data prediction neural network 122 according to the present embodiment may be trained in accordance with a training process as shown in FIG. 13. The training process may be performed by the material structure analyzer 100 or one or more external devices (not shown), and the trained structural data neural network 110 and the trained spectral data prediction neural network 122 may be provided to the material structure analyzer 100. Hereinafter, an embodiment of the training process performed by the material structure analyzer 100 is described.

At step S401, the material structure analyzer 100 acquires a combination of structural data and spectral data for training. For example, the combination of structural data and spectral data for training may be a combination (positive data) of structural data and spectral data of the same material or a combination (negative data) of structural data and spectral data of different materials.

At step S402, the material structure analyzer 100 inputs the acquired training structural data into the to-be-trained structural data neural network 110.

At step S403, the material structure analyzer 100 acquires a structural feature from the structural data neural network 110 and inputs the acquired structural feature into the spectral data prediction neural network 122.

At step S404, the material structure analyzer 100 acquires the predicted spectral data from the spectral data prediction neural network 122 and updates parameters of the structural data neural network 110 and the spectral data prediction neural network 122 in accordance with the backpropagation method based on an error between the predicted spectral data and the training spectral data.

At step S405, the material structure analyzer 100 determines whether a termination condition is satisfied. The termination condition may be, for example, completion of processing on a predetermined number of training data, convergence of updated amounts of the parameters or the like.

If the termination condition is satisfied (S405: YES), the material structure analyzer 100 terminates the training process and stores the finally acquired structural data neural network 110 and the finally acquired spectral data prediction neural network 122 as the trained structural data neural network 110 and the trained spectral data prediction neural network 122.

On the other hand, if the termination condition is not satisfied (S405: NO), the material structure analyzer 100 returns to step S401 and processes the next training data.

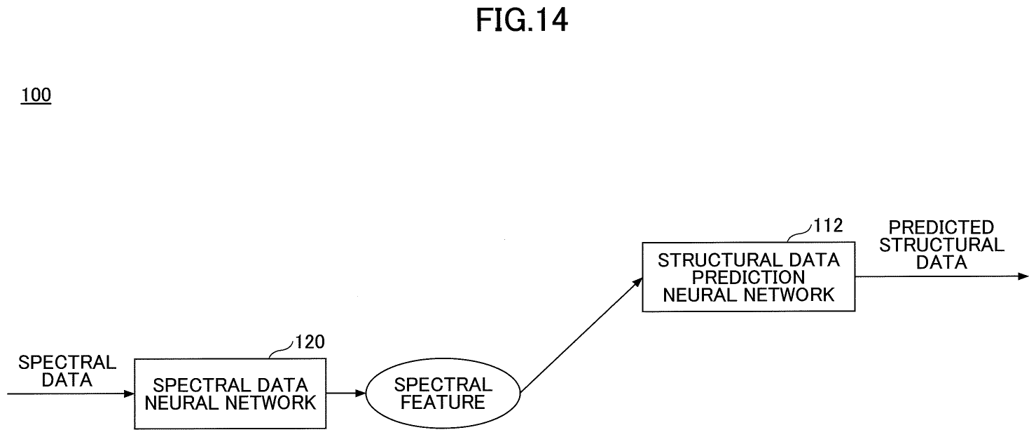

Next, the material structure analyzer according to one embodiment of the present disclosure is described with reference to FIGS. 14 to 16. In this embodiment, upon acquiring spectral data of a material, the material structure analyzer 100 predicts structural data corresponding to the material having the acquired spectral data. FIG. 14 is a schematic diagram for illustrating the material structure analyzer according to one embodiment of the present disclosure.

As shown in FIG. 14, the material structure analyzer 100 includes the spectral data neural network 120 and a structural data prediction neural network 112. However, the material structure analyzer 100 according to the present disclosure may not necessarily include all or a part of the spectral data neural network 120 and the structural data prediction neural network 112 and may access and use all or the part of the spectral data neural network 120 and the structural data prediction neural network 112 stored in one or more external devices (not shown).

The spectral data neural network 120 extracts a spectral feature from spectral data representing the spectrum of a material. As stated above, the spectral data neural network 120 may be a convolutional neural network.

The structural data prediction neural network 112 predicts structural data of the material from the spectral feature.

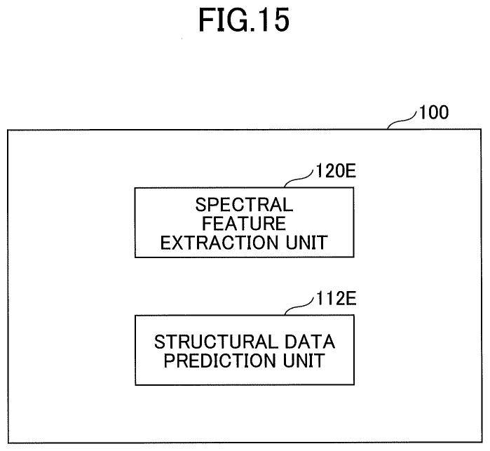

FIG. 15 is a block diagram for illustrating a functional arrangement of the material structure analyzer according to one embodiment of the present disclosure. As shown in FIG. 15, the material structure analyzer 100 includes a spectral feature extraction unit 120E and a structural data prediction unit 112E. The spectral feature extraction unit 120E is the same as the spectral feature extraction unit 120A as stated above with reference to FIG. 2, and description thereof is omitted to avoid duplication of the description.

The structural data prediction unit 112E predicts structural data of a to-be-analyzed material from the spectral feature with use of the structural data prediction neural network 112. Namely, the structural data prediction unit 112E inputs the spectral feature acquired from the spectral feature extraction unit 120E to the structural data prediction neural network 112 to acquire the structural data from the structural data prediction neural network 112. The acquired structural data is the structural data of the material corresponding to the incoming spectral data to the spectral data neural network 120.

In one embodiment, the material structure analyzer 100 may generate a plurality of candidate spectral features by varying the acquired spectral feature finely and then generate a plurality of structural data from the generated spectral features.

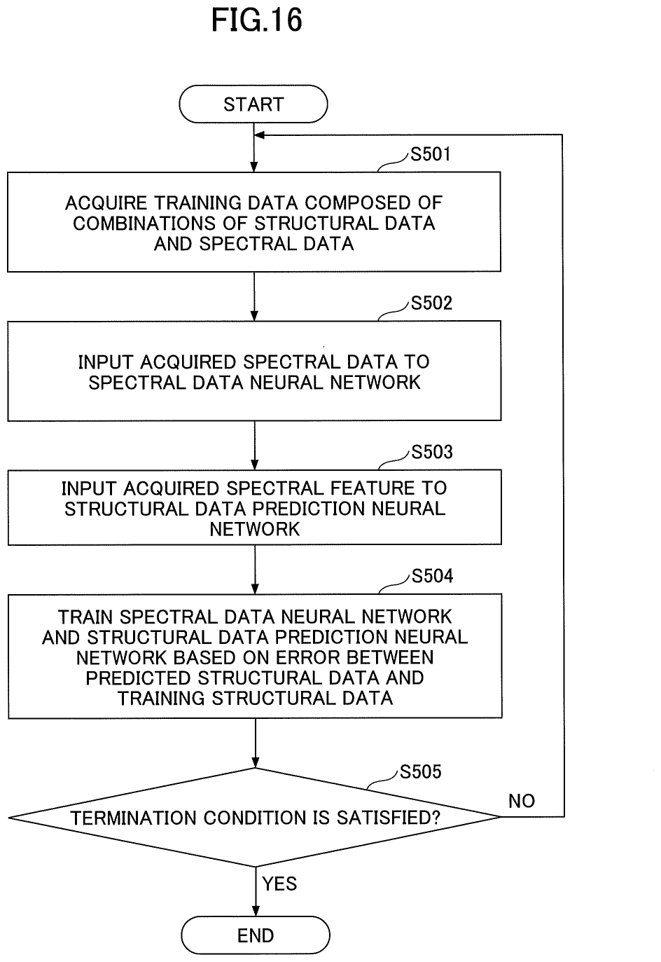

The spectral data neural network 120 and the structural data prediction neural network 112 in the material structure analyzer 100 according to the present embodiment may be trained in accordance with a training process as shown in FIG. 16. The training process may be performed by the material structure analyzer 100 or one or more external devices (not shown), and the trained spectral data neural network 120 and the trained structural data prediction neural network 112 may be provided to the material structure analyzer 100. Hereinafter, an embodiment of the training process performed by the material structure analyzer 100 is described.

At step S501, the material structure analyzer 100 acquires a combination of structural data and spectral data for training. For example, the combination of structural data and spectral data for training may be a combination (positive data) of structural data and spectral data of the same material or a combination (negative data) of structural data and spectral data of, different materials.

At step S502, the material structure analyzer 100 inputs the acquired training spectral data into the to-be-trained spectral data neural network 120.

At step S503, the material structure analyzer 100 acquires a spectral feature from the spectral data neural network 120 and inputs the acquired spectral feature into the structural data prediction neural network 112.

At step S504, the material structure analyzer 100 acquires the predicted structural data from the structural data prediction neural network 112 and updates parameters of the spectral data neural network 120 and the structural data prediction neural network 112 in accordance with the backpropagation method based on an error between the predicted structural data and the training structural data.

At step S505, the material structure analyzer 100 determines whether a termination condition is satisfied. The termination condition may be, for example, completion of processing on a predetermined number of training data, convergence of updated amounts of the parameters or the like.

If the termination condition is satisfied (S505: YES), the material structure analyzer 100 terminates the training process and stores the finally acquired spectral data neural network 120 and the finally acquired structural data prediction neural network 112 as the trained spectral data neural network 120 and the trained structural data prediction neural network 112.

On the other hand, if the termination condition is not satisfied (S505: NO), the material structure analyzer 100 returns to step S501 and processes the next training data.

In one embodiment, the material structure analyzer 100 may have the spectral data neural networks 120 corresponding to spectral types. As described above, to-be-processed spectral data relate to various types of spectral measurements, such as mass spectra by mass spectrometry, infrared (IR) spectra, X-ray spectra, Raman spectroscopy spectra, NMR (Nuclear Magnetic Resonance) spectra by nuclear magnetic resonance spectroscopy and spectra by LIBS (Laser-Induced Breakdown Spectroscopy). In the above-stated embodiments, a neural network such as the spectral data neural network 120 is provided for any one type of spectrum. In the present embodiment, neural networks corresponding to respective types of spectra such as the spectral data neural network 120 are provided, and if multiple types of spectral data are acquired for a to-be-analyzed material, the material structure analyzer 100 may use the neural networks, such as the spectral data neural network 120, corresponding to the acquired types of spectra to calculate a plurality of degrees of coincidence between the to-be-analyzed material and respective candidate materials and predict the to-be-analyzed material from the calculated degrees of coincidence. For example, if the degrees of coincidence determined for the respective types of spectra are normalized to a common range, the to-be-analyzed material may be predicted from candidate materials having a higher percent of the degrees of coincidence.

In another embodiment, the material structure analyzer 100 may include a neural network, such as the spectral data neural network 120, that can accept multiple types of spectral data as inputs. Namely, the multiple types of spectral data may be input to the single spectral data neural network 120 to extract a spectral feature corresponding to a collection of the multiple types of spectral data.

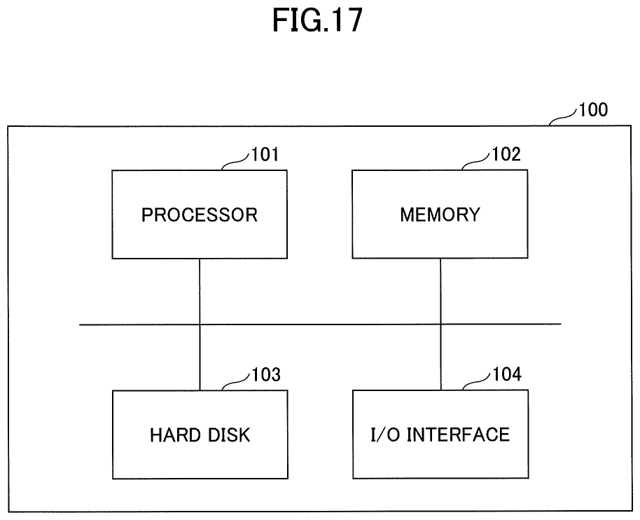

Here, as shown in FIG. 17, the material structure analyzer 100 may have a hardware arrangement with a processor 101 such as a CPU (Central Processing Unit) and a GPU (Graphics Processing Unit), a memory 102 such as a RAM (Random Access Memory) and a flash memory, a hard disk 103 and an I/O (Input/Output) interface 104, for example.

The processor 101 performs various processes for the material structure analyzer 100 as described above.

The memory 102 serves as a working memory for temporarily storing various data and programs for the material structure analyzer 100. The memory 102 acquires data and programs for implementing the various neural networks and functional units as described above from the hard disk 103 and loads them for execution by the processor 101.

The hard disk 103 stores various data and programs for the material structure analyzer 100. The hard disk 103 stores data and programs for implementing the various neural networks and functional units as described above.

The I/O interface 104 is an interface for exchanging data to external devices. For example, the I/O interface 104 is a device for inputting and outputting data such as a USB (Universal Serial Bus), a communication line, a keyboard, a mouse and a display.

In one embodiment, the material structure analyzer 100 may include one or more processors 101 and one or more memories 102 interconnected with each other. The memory 102 may store one or more combinations of two or more of the structural data neural network 110, the structural data reconstruction neural network 111, the structural data prediction neural network 112, the spectral data neural network 120, the spectral data reconstruction neural network 121 and the spectral data prediction neural network 122. The processor 101 may use these neural networks to serve to implement combinations of two or more of the structural feature extraction unit 110, the spectral feature extraction unit 120, the coincidence determination unit 130, the structural data reconstruction unit 111, the spectral data reconstruction unit 121, the structural data prediction unit 112 and the spectral data prediction unit 122 as stated above.

However, the material structure analyzer 100 according to the present disclosure is not limited to the hardware arrangement described above and may include any other suitable hardware arrangement. For example, some or all of the above-described processes by the material structure analyzer 100 may be implemented with a processing circuitry or an electronic circuitry having wirings to implement these processes.

The present disclosure is not limited to the above-stated specific embodiments, and various variations and modifications can be made without deviating from the scope of claims.

What is claimed is

1. A material structure analysis method, comprising:
acquiring, by one or more processors, structural data representing a structure of a material and spectral data representing a spectrum of a material;
inputting, by the one or more processors, the structural data to a first neural network to acquire a structural feature from the first neural network;
inputting, by the one or more processors, the spectral data to a second neural network to acquire a spectral feature from the second neural network; and
determining, by the one or more processors, a degree of coincidence between the material corresponding to the structural data and the material corresponding to the spectral data based on the structural feature and the spectral feature.

2. The material structure analysis method as claimed in claim 1, wherein a positive pair of structural data and spectral data of a same material and a negative pair of structural data and spectral data of different materials are used to train the first neural network and the second neural network to have a higher degree of coincidence for the positive pair and a lower degree of coincidence for the negative pair.

3. The material structure analysis method as claimed in claim 1, wherein a positive pair of structural data and spectral data of a same material and a negative pair of structural data and spectral data of different materials are used to train the first neural network and the second neural network to have a larger difference between the degree of coincidence for the positive pair and the degree of coincidence for the negative pair.

4. The material structure analysis method as claimed in claim 1, wherein the first neural network is a graph convolutional neural network, and the second neural network is a convolutional neural network.

5. The material structure analysis method as claimed in claim 1, wherein the first neural network and the second neural network, together with a first reconstruction neural network to reconstruct structural data from the structural feature extracted by the first neural network for the incoming structural data, are trained based on an error between the reconstructed structural data and the incoming structural data and the degree of coincidence determined based on the structural feature and the spectral feature.

6. The material structure analysis method as claimed in claim 1, wherein the first neural network and the second neural network, together with a second reconstruction neural network to reconstruct spectral data from the spectral feature extracted by the second neural network for the incoming spectral data, are trained based on an error between the reconstructed spectral data and the incoming spectral data and the degree of coincidence determined based on the structural feature and the spectral feature.

7. A material structure analyzer, comprising;
one or more memories; and
one or more processors configured to:
extract a structural feature from structural data representing a structure of a material with use of a first neural network;
extract a spectral feature from spectral data representing a spectrum of a material with use of a second neural network; and
determine a degree of coincidence between the material corresponding to the structural data and the material corresponding to the spectral data based on the structural feature and the spectral feature.

8. The material structure analyzer as claimed in claim 7, wherein a positive pair of structural data and spectral data of a same material and a negative pair of structural data and spectral data of different materials are used to train the first neural network and the second neural network to have a higher degree of coincidence for the positive pair and a lower degree of coincidence for the negative pair.

9. The material structure analyzer as claimed in claim 7, wherein a positive pair of structural data and spectral data of a same material and a negative pair of structural data and spectral data of different materials are used to train the first neural network and the second neural network to have a larger difference between the degree of coincidence for the positive pair and the degree of coincidence for the negative pair.

10. The material structure analyzer as claimed in claim 7, wherein the first neural network is a graph convolutional neural network, and the second neural network is a convolutional neural network.

11. The material structure analyzer as claimed in claim 7, wherein the first neural network and the second neural network, together with a first reconstruction neural network to reconstruct structural data from the structural feature extracted by the first neural network for the incoming structural data, are trained based on an error between the reconstructed structural data and the incoming structural data and the degree of coincidence determined based on the structural feature and the spectral feature.

12. The material structure analyzer as claimed in claim 7, wherein the first neural network and the second neural network, together with a second reconstruction neural network to reconstruct spectral data from the spectral feature extracted by the second neural network for the incoming spectral data, are trained based on an error between the reconstructed spectral data and the incoming spectral data and the degree of coincidence determined based on the structural feature and the spectral feature.

13. A storage medium for storing a program that causes one or more processors to perform operations comprising:
acquiring structural data representing a structure of a material and spectral data representing a spectrum of a material;
inputting the structural data to a first neural network to acquire a structural feature from the first neural network;
inputting the spectral data to a second neural network to acquire a spectral feature from the second neural network; and
determining a degree of coincidence between the material corresponding to the structural data and the material corresponding to the spectral data based on the structural feature and the spectral feature.

14. The storage medium as claimed in claim 13, wherein a positive pair of structural data and spectral data of a same material and a negative pair of structural data and spectral data of different materials are used to train the first neural network and the second neural network to have a higher degree of coincidence for the positive pair and a lower degree of coincidence for the negative pair.

15. The storage medium as claimed in claim 13, wherein a positive pair of structural data and spectral data of a same material and a negative pair of structural data and spectral data of different materials are used to train the first neural network and the second neural network to have a larger difference between the degree of coincidence for the positive pair and the degree of coincidence for the negative pair.

16. The storage medium as claimed in claim 13, wherein the first neural network is a graph convolutional neural network, and the second neural network is a convolutional neural network.

17. The storage medium as claimed in claim 13, wherein the first neural network and the second neural network, together with a first reconstruction neural network to reconstruct structural data from the structural feature extracted by the first neural network for the incoming structural data, are trained based on an error between the reconstructed structural data and the incoming structural data and the degree of coincidence determined based on the structural feature and the spectral feature.

18. The storage medium as claimed in claim 13, wherein the first neural network and the second neural network, together with a second reconstruction neural network to reconstruct spectral data from the spectral feature extracted by the second neural network for the incoming spectral data, are trained based on an error between the reconstructed spectral data and the incoming spectral data and the degree of coincidence determined based on the structural feature and the spectral feature.
